(19) United States
(12) Patent Application Publication
(10) Pub. No.: US 2006/0075684 A1
(43) Pub. Date: Apr. 13, 2006

(54) Hydraulic door actuator

(75) Inventors: Holger Hansch, Witten (DE); Thomas Wildforster, Schwelm (DE)

Correspondence Address: COHEN, PONTANI, LIEBERMAN & PAVANE, 551 FIFTH AVENUE, SUITE 1210, NEW YORK, NY, 10176, US

(73) Assignee: DORMA GMBH+co., KG, ENNEPETAL (DE)

(21) Appl. No.: 10/529,674

(22) PCT Filed: May 26, 2004
(86) PCT No.: PCT/EP04/05639

§ 371 Date: Mar. 29, 2005

(30) Foreign Application Priority Data
Jun. 3, 2003 (DE) 103-24-127.2

(51) Int. Cl. E05F 15/02

(52) U.S. Cl. 49/340; 49/356

(57) ABSTRACT

A hydraulic door drive includes a working piston and an auxiliary separated by a spring in a common piston space. A hydraulic circuit connects a first pressure space on a side of working piston facing away from the spring, and a second working space on a side of the auxiliary piston facing away from the spring. A power and control unit controls the pressure generated in the hydraulic circuit by a motor driven pump based on the position of the working piston, as determined by a position transducer.

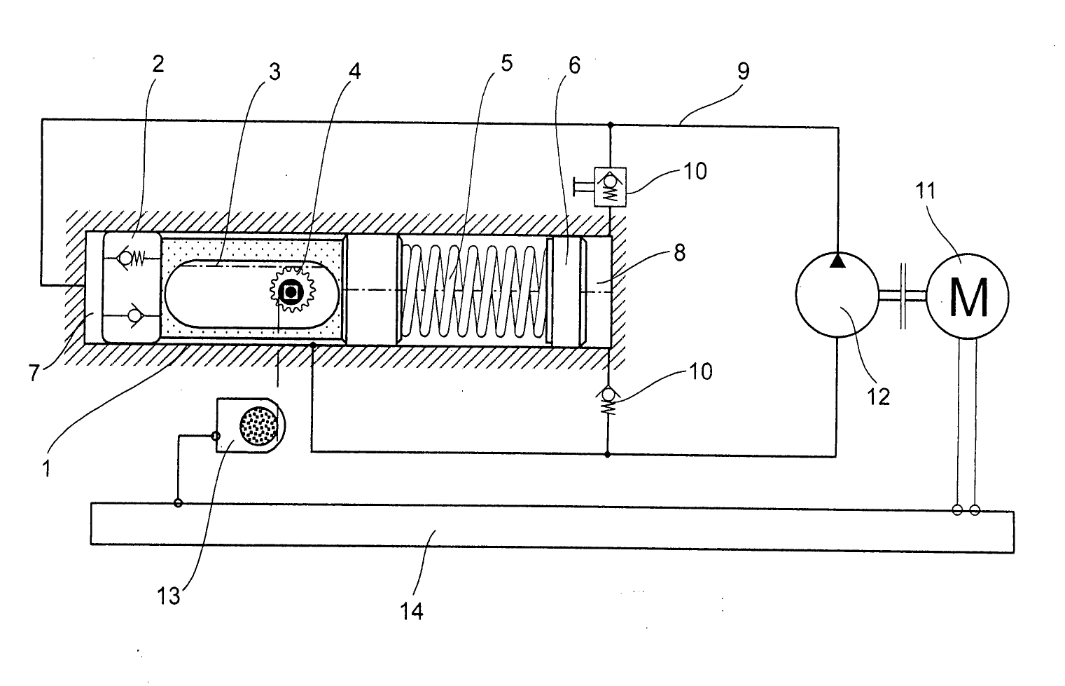

The invention pertains to a hydraulic door drive in which a working piston can be moved hydraulically against the force of a spring and in which the force of the spring can be adjusted.

The closing forces of hydraulic door closers with automatic opening mechanisms are often adjustable so that they can be adapted to different situations on site. For this purpose, a threaded spindle is usually used, which can be used to adjust the force of the spring. This leads to the problem, however, that the precision with which the spring force can be adjusted is relatively low.

It is therefore the task of the present invention to create a hydraulic door drive in which the spring force can be adjusted to a precisely defined value.

This task is accomplished by the features stated in claim 1. Advantageous elaborations can be derived from the subclaims.

It is proposed that the spring force be adjusted hydraulically.

Because the force of the spring is adjusted hydraulically, the force can be adjusted with greater precision than is possible with a threaded spindle used for the same purpose.

In accordance with an advantageous elaboration, the spring is supported on a hydraulically movable auxiliary piston. By means of the auxiliary piston, the spring can be adjusted with fineness and with precision.

The end of the spring facing away from the auxiliary piston is preferably supported directly on the working piston.

It is advantageous to install the working piston and the auxiliary piston in a common piston space.

In accordance with a preferred embodiment, a first pressure space is located in the piston space on the side of the working piston facing away from the spring, and a second pressure space is provided on the side of the auxiliary piston facing away from the spring. When, in addition, the two pressure spaces are connected to the same hydraulic circuit, it is possible easily to control the inventive door closer by either open-loop or closed-loop control.

According to an advantageous embodiment, the working piston cooperates with a position transducer, especially an incremental rotary transducer, so that the exact position of the working piston can be determined at any time.

So that the spring and the displacement of the piston can be controlled easily and simply by means of either open-loop or closed-loop control, it is advantageous to provide a motorized pump in the hydraulic circuit and also to provide a power and control unit.

Additional features and advantages of the invention can be derived from the following description of a preferred exemplary embodiment.

The single FIGURE shows a schematic diagram of an inventive hydraulic door drive with automatic closer.

The diagram shows only the parts which are of relevance here; all of the other design elements have been omitted for the sake of clarity.

In a common piston space 1 of a door closer with automatic opening mechanism, a working piston 2 is supported with freedom of back-and-forth movement. The working piston 2 is provided in the known manner with, for example, a set of teeth 3, which meshes with the pinion 4 of the door drive.

In the piston space there is also a spring 5, against which the working piston 2 can be moved. The spring 5 is supported at one end against the working piston 2 and at the other end against an auxiliary piston 6, which is also provided in the piston space 1.

On the side of the working piston 2 facing away from the spring 5 there is a first pressure space 7, and on the side of the auxiliary piston 6 facing away from the spring 5 there is a second pressure space 8. The two pressure spaces 7, 8 are connected to a motor (11)—driven pump 12 in such a way that the same pressure is present in both spaces 7, 8.

An incremental rotary transducer 13 is also provided, which can be used to determine the exact position of the working piston 2 at any time.

A power and control unit 14 is provided so that the door drive can be operated by either open-loop or closed-loop control.

In the inventive door drive, the force of the spring can be adjusted to set the closing forces as follows:

The auxiliary piston 6 and the working piston 2 can be pushed in a linear manner by pumping up the pressure in the two pressure spaces 7, 8. As this happens, the working piston 2 and the auxiliary piston 6 move toward each other and increase the tension on the spring 5 situated between them.

The linear position of the working piston 2 at the moment in question can be determined directly by the incremental rotary transducer 13. Because the working piston 2 and the auxiliary piston 6 travel the same distance when the pressure acts upon them, the power and control unit 14 can calculate and thus specify in advance the amount of spring pretension.

When the desired pretension for the closing force, which has been entered on a keyboard, for example, is reached, the power and control unit 14 automatically adjusts the pump pressure by way of the motor current in such a way that the distance between the working piston 1 and the auxiliary piston 6 is kept constant. When, in this state, someone tries to close the door, for example, and thus applies a movement from the outside to the working piston 2 via the pinion 4, the working piston 2 can be pushed into its closed-door rest position. Because the auxiliary piston 6 and the working piston 2 are both under the same pressures in this state, the fluid column present in the piston space 1 can be shifted without the expenditure of force and without any change in the distance between the working piston 2 and the auxiliary piston 6.

To check the value of the pretension of the spring 5, the door can be moved by hand into its two stop positions in the settled state. In these end positions, pulses can be transmitted to the power and control unit 14 which allow the pretensioned position of the spring 5 to be calculated. By repeating this procedure with finely adjusted input values, the desired spring force can be set in a defined manner.

After the spring force has been adjusted successfully, the auxiliary piston 6 can be fixed in the appropriate position by hydraulic and/or mechanical means.

### LIST OF REFERENCE NUMBERS

1 piston space
2 working piston
3 set of teeth
4 pinion
5 spring
6 auxiliary piston
7 first pressure space
8 second pressure space
9 lines
10 valves
11 motor
12 pump
13 incremental rotary transducer
14 power and control unit

1-8. (canceled)

9. A hydraulic door drive comprising:
a hydraulically movable working piston;
a spring exerting a spring force against the piston; and
means for adjusting the spring force hydraulically.

10. The hydraulic door drive of claim 9 further comprising a hydraulically movable auxiliary piston, the spring being supported against said hydraulically movable auxiliary piston.

11. The hydraulic door drive of claim 10 wherein the spring is located between the working piston and the hydraulically movable piston.

12. The hydraulic door drive of claim 11 wherein the working piston, the auxiliary piston, and the spring are located in a common piston space.

13. The hydraulic door drive of claim 12 further comprising a first pressure space in said piston space on a side of the working piston facing away from the spring, and a second pressure space in said piston space on a side of the auxiliary piston facing away from the spring.

14. The hydraulic door drive of claim 13 wherein said means for adjusting the spring force hydraulically comprises a hydraulic circuit connected to said first and second pressure spaces.

15. The hydraulic door drive of claim 14 further comprising a motor driven pump which generates pressure in the hydraulic circuit, and a power and control unit which controls the pressure generated by the motor driven pump.

16. The hydraulic door drive of claim 15 further comprising a position transducer which detects the position of the working piston, said power and control unit generating said pressure as a function of the position of the working piston.

17. The hydraulic door drive of claim 16 wherein the position transducer is an incremental rotary transducer.
